(19) United States
(12) Patent Application Publication
(10) Pub. No.: US 2026/0298373 A1
(43) Pub. Date: Oct. 1, 2026

(54) FLEXIBLE CORD RETAINING DEVICE

(71) Applicant: Frank T. Chavez, Byron, MN (US)

(72) Inventors: Frank T. Chavez, Byron, MN (US); Ronald Carl Johansson, Oak Park Heights, MN (US)

(21) Appl. No.: 19/577,770

(22) Filed: Mar. 25, 2026

Related U.S. Application Data
(60) Provisional application No. 63/778,803, filed on Mar. 27, 2025.

(51) Int. Cl. F16L 3/137

(52) U.S. Cl. CPC F16L 3/137

(57) ABSTRACT

Described herein are devices for securing and/or retaining flexible cords associated with a variety of objects, including for example, electrical cords associated with appliances. Also described are methods of using such cord retaining devices to facilitate convenient storage and future use.

### CROSS-REFERENCE TO RELATED APPLICATIONS

This application claims priority to U.S. Provisional Patent Application Ser. No. 63/778,803, filed Mar. 27, 2025, the contents of which are hereby incorporated by reference in its entirety.

### TECHNICAL FIELD

This disclosure relates generally to devices for retaining flexible cords associated with objects, including for example, electrical cords associated with appliances.

### BACKGROUND

Many objects and appliances have a flexible cord extending therefrom. In particular, electrical appliances often have an electrical power extending therefrom. Similarly, some appliances may have a flexible hose or tube extending therefrom for delivering and/or removing a fluid, such as air or water; such appliances may include pumps, vacuums, air compressors, etc. In use, these objects and appliances may have their associated cord straightened and/or extended, whereas following use, the cord may be bundled or wrapped near the associated object to facilitate storage. A need exists for improved devices for securing or retaining such cords for storage, and for subsequently ensuring such cords are readily available for future use.

### BRIEF DESCRIPTION OF THE DRAWINGS

The following drawings are illustrative of particular examples of a retaining device according to embodiments of this disclosure and therefore do not limit the scope of invention. The drawings are not necessarily to scale, though embodiments can include the scale illustrated, and are intended for use in conjunction with the explanations in the following detailed description wherein like reference characters denote like elements. Embodiments of this disclosure will hereinafter be described in conjunction with the appended drawings.

FIG. 1A is a front view of an embodiment of a retaining device, in accordance with one or more examples of this disclosure.

FIG. 1B is a perspective view of an embodiment of a retaining device in use, in accordance with one or more examples of this disclosure.

FIG. 2A is a front view of an embodiment of a retaining device, in accordance with one or more examples of this disclosure.

FIG. 2B is a front view of an embodiment of a retaining device, in accordance with one or more examples of this disclosure.

FIG. 2C is a front view of an embodiment of a retaining device, in accordance with one or more examples of this disclosure.

FIG. 3A is a front view of an embodiment of a retaining device, in accordance with one or more examples of this disclosure.

FIG. 3B is a partial perspective view of an embodiment of a head portion of a retaining device, in accordance with one or more examples of this disclosure.

FIG. 3C is a side view of an embodiment of a retaining device in use, in accordance with one or more examples of this disclosure.

FIG. 3D is a side view of an embodiment of a retaining device in use, in accordance with one or more examples of this disclosure.

FIG. 4A is a perspective view of an embodiment of a retaining device in use, in accordance with one or more examples of this disclosure.

FIG. 4B is a perspective view of an embodiment of a retaining device in use, in accordance with one or more examples of this disclosure.

FIG. 5A is a perspective view of an embodiment of a retaining device in use with an appliance, in accordance with one or more examples of this disclosure.

FIG. 5B is a perspective view of an embodiment of this disclosure showing two retaining devices in use with a pair of extension cords, in accordance with one or more examples of this disclosure.

FIG. 6 is a perspective view of an embodiment of a retaining device in use, in accordance with one or more examples of this disclosure.

### DETAILED DESCRIPTION

Various objects having flexible cords attached thereto (or extending therefrom) may need to be maneuvered, positioned, or stored, each of which can alter the position of the flexible cord. In order to prevent the cord from tangling (e.g., upon itself or other objects) and/or becoming damaged, it can be beneficial to secure all or a portion of the cord in a coiled or looped configuration. In some cases, it may further be desirable to affix or secure the coiled or looped cord relative to the body of the object (e.g., in proximity to the object). A retaining device according to this disclosure can be used to secure and/or position the flexible cord relative to the object.

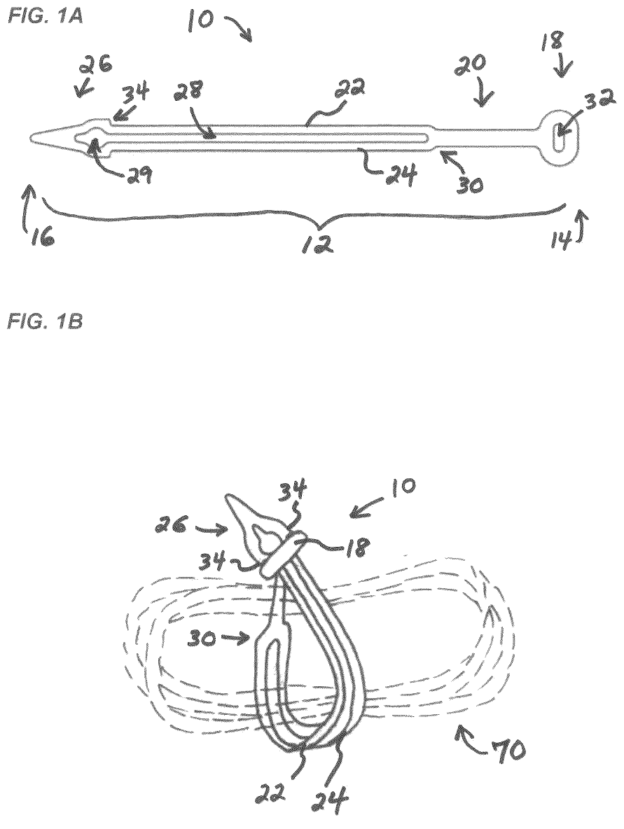

The embodiments described herein include a retaining device 10 for an object having a flexible cord extending therefrom. An exemplary retaining device 10 is shown in FIG. 1A. The retaining device 10 can include an elongate body 12. The elongate body 12 can be positioned around a cord and/or an object to which the cord is attached. The elongate body 12 can be formed of a flexible, deformable material. This can facilitate attachment of the retaining device 10 around the cord and/or the body of the object (or a portion thereof), as discussed elsewhere herein. It should be noted that the retaining devices of this disclosure could be formed by injection molding or by extrusion processes, for example. It is also contemplated that the retaining devices of this disclosure could be formed by producing two or more pieces and coupling them together to form the retaining device, according to some embodiments of this disclosure.

The elongate body 12 can include a variety of structural features. The elongate body 12 can extend along a longitudinal axis from a first end 14 to a second end 16. The elongate body 12 can include a head portion 18, a neck portion 20, a first leg 22, a second leg 24, and a foot portion 26, as shown in FIG. 1A. The head portion 18 can be adjacent the neck portion 20, which can in turn be adjacent to the first and second legs 22, 24. The foot portion 26 can be disposed distal to the first and second legs 22, 24, which may in turn extend distally from the neck portion 20. In some embodiments, the first and second legs 22, 24, may have an elongate opening 28 formed between the first and second legs 22, 24, generally as shown in FIG. 1A. In some embodiments, the first and second legs 22, 24 may extend outwardly from the longitudinal axis to form a hip (or hips) 30 at the transition from the neck portion 20 to the first and second legs 22, 24, according to some embodiments.

The elongate body 12 can be configured for use with various objects and/or applications. For example, in a further embodiment, the elongate body 12 can be formed of a flexible rubber material. In some embodiments, the elongate body 12 can be any length to suit a particular use or application. In some embodiments, the elongate body 12 may be between about 5 inches and 5 feet in length. The elongate body 12 can be any length and any material that can allow the retaining device 10 to be positioned around a cord and/or an associated object. (Note: In some cases, a flexible cord may be detachable from an associated object, e.g., unplugged in the case of an electrical appliance. This disclosure contemplates using a retaining device 10 of this disclosure to retain a coiled or looped cord in proximity to its associated object despite not being physically or electrically coupled or attached.) The elongate body 12 can be homogenously formed of one material. In other embodiments, the elongate body 12 may be formed of different materials. For example, it may be desirable in some applications for the head portion 18 to be formed of a somewhat more rigid material than, for example, the first and second legs, 22, 24.

The first end 14 of the elongate body 12 can have various features. For example, the head portion 18 can be disposed near the first end 14 of the elongate body 12. The head portion 18 can include a first slit 32. The first slit 32 can be oriented generally transverse to the longitudinal axis of the elongate body 12. In some embodiments, the first slit 32 can have an oval shape as shown in FIG. 1A, or it could have a different shape (e.g., rectangular). The first slit 32 can be configured (e.g., sized, shaped, etc.) to receive the foot portion 26 of the elongate body 12 positioned or pulled therethrough. In some embodiments, the first slit 32 may be configured to elastically deform and/or open to receive the foot portion 26 as it is pulled therethrough, and then elastically deform and/or constrict to retain the foot portion 26 in an engaged position pulled through the first slit 32. (NOTE: As used herein, the term “slit” or “slits” refers to an opening or aperture of any suitable shape or orientation; the slits are not necessarily oval in shape, nor are they necessarily transversely oriented. For example, the aforementioned slits can be holes or apertures of any suitable shape, such as rectangular, square, oval, circular, etc., and the orientation need not be transverse to a longitudinal axis of the elongate body of the retaining device. The examples described herein are illustrative in nature and should not be deemed to limit the scope of the claims appended hereto.)

The neck portion 20 can be disposed adjacent the head portion 18 of the elongate body 12 and can extend distally from the head portion 18. In some embodiments, the head portion 18 can be generally wider than the neck portion 20. The neck portion 20 can be a longer length than the head portion 18 (e.g., longer as measured along the longitudinal axis).

The first and second legs 22, 24 can be disposed adjacent the neck portion 20, as noted above and as shown in FIG. 1A. The first and second legs 22, 24 can extend distally from the neck portion 20, forming an elongate opening 28 disposed between the first and second legs 22, 24. The elongate opening 28 can include a central portion, and in some embodiments, may further include one or more enlarged portions 29 disposed at one end (or optionally, at both opposite ends) of the central portion. In the embodiment shown in FIG. 1A, a single enlarged portion 29 is shown disposed at a distal end of a relatively narrow central portion of the elongate opening 28; enlarged portion 29 is shown disposed at or within the foot portion 26 in the particular embodiment depicted. While the embodiments herein are described and shown as having first and second legs 22, 24, the retaining device 10 may be formed with three, four, five, or more legs. The retaining device 10 may have any number of legs, for example, to facilitate positioning the retaining device 10 and a looped or coiled cord relative to an associated object.

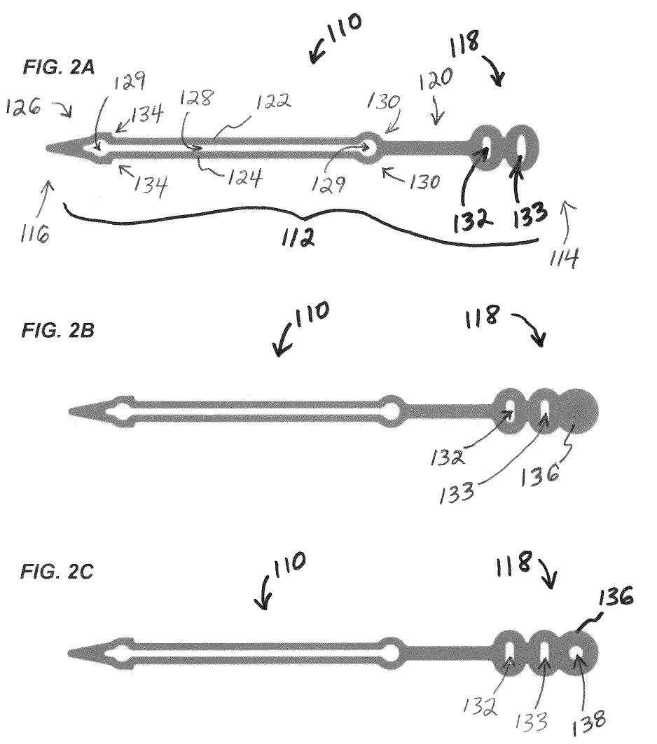

The first and second legs 22, 24, may each form a hip 30, for example, at or near a point where the neck portion 20 transitions to the first and second legs 22, 24. For example, the retaining device 10 may include a first hip 30 at a proximal end of the first leg 22 and a second hip 30 at a proximal end of the second leg 24. The first and second hips 30 can extend outwardly from the longitudinal axis of the elongate body 12. In some embodiments, the first and second hips 30 may extend outwardly to a width that is greater than the width between the first and second legs 22, 24 when the first and second legs 22, 24 are not positioned around an object (e.g., in an undeformed position). This may be seen more clearly with reference to the embodiments depicted in FIGS. 2A-2C, for example.

The first and second hips 30 can facilitate the positioning of the elongate body 12, for example, to secure a portion of a coiled cord. For example, the hips 30 may be configured (e.g., sized, shaped) to be pulled all the way through the first slit 32 (e.g., after first positioning and pulling the foot portion 26 through the first slit 32). The width of the hips 30 can be greater than the width of the first slit 32, such that the first slit 32 can be deformably opened (e.g., stretched) to enable the hips 30 to be passed through and then retained in position. When the hips 30 are positioned through first slit 32 in this manner, neck portion 20 forms a relatively tight loop near the head portion 18. The tight loop formed by the neck portion 20 in this configuration may, for example, facilitate securing the retaining device 10 to a single strand of the cord disposed within the relatively tight loop; doing so may function to keep the retaining device 10 connected to the flexible cord of the object, even when it is not being used to hold the cord in a coiled/looped configuration. It is a common complaint of users of some cord retaining devices that the retaining device can be easily lost or misplaced once it has been removed from holding or securing the coiled portion of the cord. The tight loop usage of the retaining device 10 of this disclosure overcomes this shortcoming, among others.

The foot portion 26 can be disposed near the second end 16 of the elongate body 12. The foot portion 26 may form a connection between the first leg 22 and the second leg 24. The foot portion 26 can be shaped to include one or more heels 34. The one or more heels 34 may, for example, extend outwardly from the first and second legs 22, 24, at a point where the first and second legs 22, 24 transition into forming the foot portion 26. The heel (or heels) 34 of foot portion 26 may facilitate usage of the retaining device 10 to hold or secure a coiled length of cord by forming an abutting feature that can hold its position once passed through the first slit 32 of head portion 18, according to some embodiments. An example of such use is described below with reference to FIG. 1B.

FIG. 1B shows a retaining device 10 in use to retain a cord 70 in a coiled or looped configuration (shown in dashed lines). As shown in FIG. 1B, the foot portion 26 has been inserted into and through first slit 32 of head portion 18 such that the heels 34 of foot portion 26 abut against a surface of head portion 18 to thereby retain a closed loop configuration of retaining device 10 around the looped cord 70. The foot portion 26 is thereby releasably retained by the head portion 18, and the retaining device 10 forms a closed loop around all (or most) of the coiled strands of the looped cord 70. In some embodiments, the foot portion 26 may be pulled further through the first slit 32 to tighten the retaining device 10 around the looped cord 70. Alternatively, in some embodiments, the legs 22, 24 of the retaining device 10 may be wrapped two or more times around the looped cord 70 before the foot portion 26 is positioned through the first slit 32 of the head portion 18.

FIG. 2A shows another embodiment of a retaining device 110 of this disclosure wherein the head portion 118 comprises a first slit or aperture 132 and a second slit or aperture 133, the first slit 132 being disposed distally of the second slit 133 along the longitudinal axis of the elongate body 112 in the embodiment depicted. The first and second slits 132, 133 can be oriented generally transverse to the longitudinal axis of the elongate body 112. The first and second slits 132, 133 can be any shape configured to receive the foot portion 126, the hips 130, and/or the legs 122, 124 of the retaining device 110 positioned therethrough. In some embodiments, the first and second slits or apertures 132, 133 can be oval in shape as shown in FIGS. 2A-2C, or they could have a different shape (e.g., circular, rectangular, etc.). The second slit 133 may be generally the same shape as the first slit 132. In other embodiments, the second slit 133 and first slit 132 may be different shapes from each other. The foot portion 126 can be shaped to include one or more heels 134 (e.g., extending outwardly from one or both legs 122, 124). The one or more heels 134 may, for example, extend outwardly from the first and second legs 122, 124, at a point where the first and second legs 122, 124 transition into forming the foot portion 126. The heel (or heels) 134 of foot portion 126 may facilitate usage of the retaining device 110 to hold or secure a coiled length of cord by forming an abutting feature that can hold its position once passed through the first slit 132 or second slit 133 of head portion 118, according to some embodiments.

FIG. 2B shows an embodiment of the retaining device 110 wherein the head portion 118 further comprises an end tab 136 disposed proximally of the first and second slits 132, 133. The end tab 136 may be used to help maneuver or position the retaining device 110 during use. For example, the end tab 136 may serve as a pull tab and used to pull or hold the head portion 118 while positioning the foot portion 126, and/or the legs 122, 124, and/or the hips 130 through either or both of the first and second slits 132, 133. The end tab 136 can thereby facilitate adjusting or altering the size of first and/or second closed loops that may be formed by the retaining device 110, as will be discussed in more detail below.

FIG. 2C shows another illustrative example of a retaining device 110 having an end tab 136 disposed proximally of the first and second slits 132, 133. In some embodiments, the end tab 136 can include a hole 138 formed in the end tab 136 to facilitate hanging the retaining device 110 (e.g., on a hook, hanger, nail, or display rack). The hole 138 could, for example, be used to position the retaining device 110 and, in some instances, the object/appliance and cord on which the retaining device 110 is being used, on a hanger. The end tab 136 may be configured to deform less than other portions of the retaining device 110, such as the first and second legs 122, 124, for example.

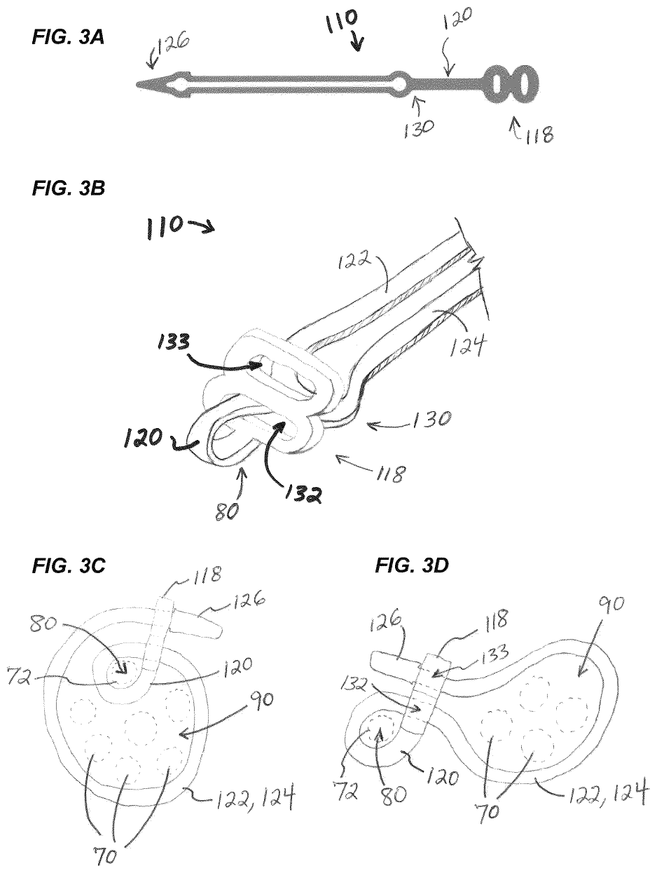

FIGS. 3A-3D show the retaining device 110 of FIG. 2A as it might be used with a looped or coiled cord according to some embodiments of this disclosure. For example, FIG. 3B shows the retaining device 110 having the neck portion 120 positioned through the first slit 132 of the head portion 118. This positioning of the neck portion 120 through the first slit 132 can thereby form the first closed loop 80 as shown. The neck portion 120 can be pulled through the first slit 132, which can adjust the size of the fist closed loop 80. In some embodiments, the length of the neck portion 120 (e.g., from the head portion 118 to the hips 130) may help determine the size of the first closed loop 80 when formed in this manner. When the retaining device 110 forms the first closed loop 80, the hips 130 may be positioned adjacent the head portion 118 near the first slit 132, for example.

FIG. 3C and FIG. 3D each show illustrative examples of how the retaining device 110 can be used to position and/or retain cord 70 in a looped or coiled configuration. In FIGS. 3C and 3D, the retaining device 110 has been positioned to form a first closed loop 80 and a second closed loop 90. First closed loop 80 is typically smaller than second closed loop 90 and is intended to capture and retain a single strand 72 of the looped/coiled cord 70 therewithin. In some embodiments, the foot portion 126 can be configured to be placed through the second slit 133 and releasably retained by the head portion 118 such that the first and second legs 122, 124 form a second closed loop 90 for retaining multiple strands of the looped/coiled flexible cord 70 therewithin.

As shown in FIG. 3C, in some embodiments, the second closed loop 90 can surround the first closed loop 80 (e.g., in a winding or coiled arrangement). In such applications, the first closed loop 80 may hold a single strand 72 of the cord 70, and the second closed loop 90 can hold multiple strands of cord 70, as shown.

FIG. 3D shows an illustrative alternative embodiment in which the first and second closed loops 80, 90 form a “Figure 8” configuration. Similar to other applications described herein, the first closed loop 80 can hold a single strand 72 of the cord 70, and the second closed loop 90 may hold multiple strands of cord 70.

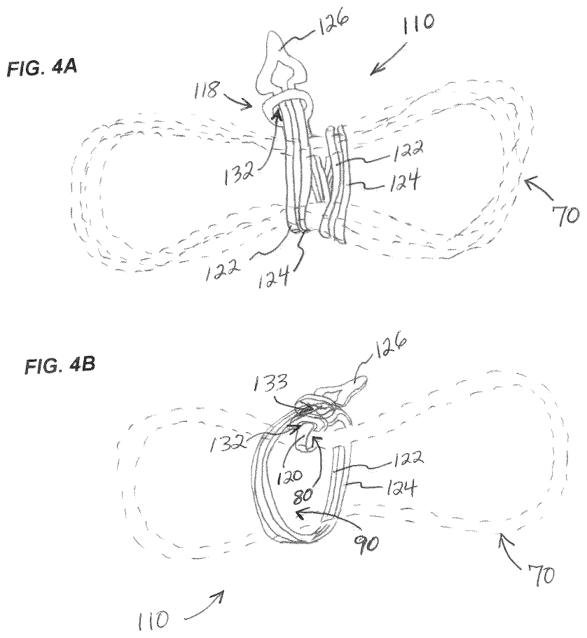

FIG. 4A shows an example of a retaining device 110 having a single slit (e.g., first slit 132) as it might be used to retain a looped cord 70. In some applications, as shown in FIG. 4A, it may be desirable to wrap the first and second legs 122, 124 of the elongate body 112 around the looped cord 70 multiple times (e.g., to form a closed loop around the cord 70) before placing the foot portion 126 into a removably retained position through slit 132 to secure the looped cord 70 within the closed loop.

FIG. 4B shows a retaining device 110 having a first slit 132 and a second slit 133 as it might be used to retain a looped cord 70 according to some embodiments. In this illustrative application, a first closed loop 80 may be formed by the neck portion 120 to hold one strand of the looped/coiled cord 70, and a second closed loop 90 may be formed to hold multiple strands of the looped/coiled cord 70. The first and second legs 122, 124 can be wrapped around the multiple strands of cord 70 one or more times, as needed. In other embodiments, the first and second legs 122, 124 can be wrapped around the multiple strands of cord 70 two, three, four, five times, or as many times as desired by a user.

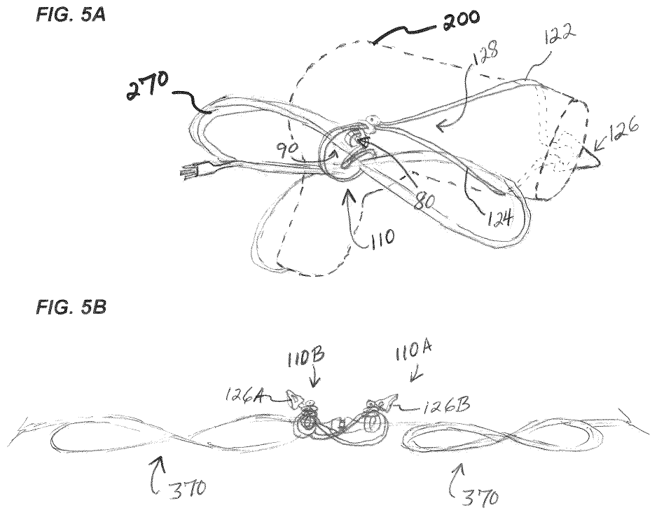

FIG. 5A shows the retaining device 110 being used to hold and position a flexible cord 270 relative to an associated object or appliance 200 (e.g., an electric power cord connected to a drill or a hair dryer, for example). The retaining device 110 may first be positioned such that a first closed loop 80 (e.g., securing a single strand of cord 270) and a second closed loop 90 (e.g., securing multiple strands of looped cord 270) are formed. The first closed loop 80 can be wrapped around one strand of cord 270 and the second closed loop 90 is wrapped around multiple strands of cord 270. The elongate opening 128 formed between legs 122, 124 can be configured to be stretched to enable placement of the first and second legs 122, 124 over the object 200, or onto a protruding portion of the object 200, as possible examples.

The retaining device 110 can be used with a variety of objects 200. For example, the object 200 can be an electrical appliance, and the flexible cord 270 extending from the electrical appliance 200 may be an electrical cord in some embodiments. Additionally or alternatively, the object 200 could be a gas or fluid appliance and the flexible cord extending from the gas or fluid appliance can be a flexible hose or other fluid conduit. In yet another embodiment, the object can be an air compressor. Alternatively, the object can be a hair dryer, power drill, or any other similar object having a cord or hose extending therefrom.

FIG. 5B shows another application of the retaining device 110 employing two (or more) such retaining devices 110A, 110B. In the example illustrated in FIG. 5B, two retaining devices 110A, 110B are shown being used to hold two cords 370 together. For example, in some applications, it may be desirable to connect two cables 370 (e.g., extension cords) to one another (e.g., plugged into corresponding mating ends). As with other embodiments described herein, a first closed loop is formed for each of the retaining devices 110A, 110B, with the neck portion 120 of each device 110A, 110B formed around a single strand (or relatively few strands) of each cord 370; the first closed loop may be formed generally as described above with respect to FIG. 3B to secure a single strand of the corresponding cord 370. The foot portion 126A of the first retaining device 110A can be placed through the second slit of the second retaining device 110B and releasably engaged thereto by the head portion 118 of the second retaining device 110B. Similarly, the foot portion 126B of the second retaining device 110B can be placed through the second slit of the first retaining device 110A and releasably engaged thereto by the head portion 118 of the first retaining device 110A. This configuration can be configured to provide sufficient tension around each of the cords 370 to thereby hold them together.

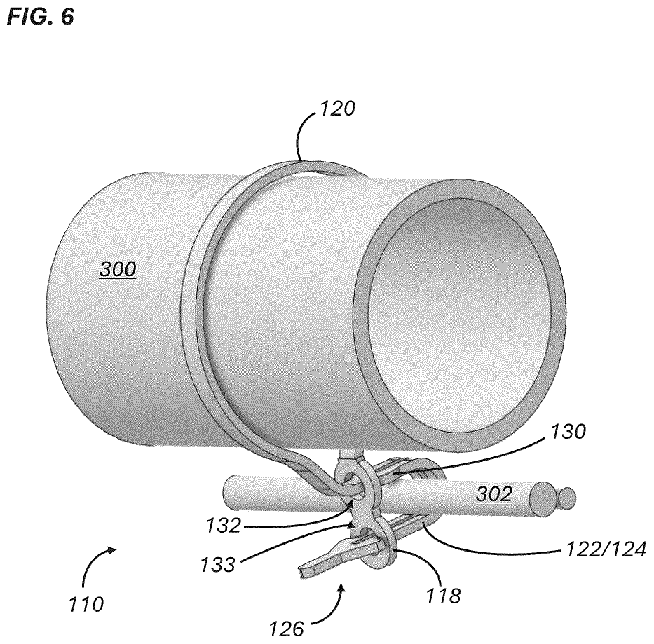

FIG. 6 is a perspective view of an embodiment of a retaining device 110 as it may be used, in accordance with one or more examples of this disclosure. As shown in the example of FIG. 6, retaining device 110 can be used to bundle one or more wires or cords 302 together and couple it to an existing fixture 300, for example to route the wire(s) or cord(s) 302 and keep them organized and/or out of the way. One possible example is to use the retaining device 110 to hang the cord or cords 302 from an overhead pipe 300 to keep the cords 302 organized and out of the way. The retaining device 110 can facilitate adding or removing individual cords to or from the bundle of cords 302 as desired, or re-routing the cord or bundle of cords 302 to a different fixture 300, for example. In some examples, the overhead pipe 300 can be coupled to or secured within a first loop formed by the neck portion 120 of the retaining device 110. As shown, after wrapping the neck portion 120 around a portion of fixture 300, the foot portion 126 and the first and second legs 122, 124 may be passed through a first aperture 132 to form the first loop; in some cases, the hips 130 of the retaining device 110 may help to retain the first loop in position relative to the fixture 300. As further shown in FIG. 6, a second loop may be formed by the retaining device 110 around the cord(s) 302 by passing the foot portion 126 through the second aperture 133 of the head portion 118. Note that the apertures 132, 133 formed in the head portion 118 of retaining device 110 can be openings that are circular, as shown in FIG. 6, or they can be any other suitable shape for an opening, such as slits, ovals, rectangles, etc.

It should also be noted that the first loop and second loop could be reversed from the way it is shown in FIG. 6. That is, the cord or cords 302 could be retained within the first loop (formed by neck portion 120), and the fixture 300 could be coupled via the second loop (formed by the first and second legs 122, 124, according to various embodiments of this disclosure.

Various non-limiting exemplary embodiments have been described. It will be appreciated that suitable alternatives are possible without departing from the scope of the examples described herein.

What is claimed is:

1. A retaining device for an object having a flexible cord extending therefrom, the retaining device including an elongate body formed of a flexible, deformable material, the elongate body extending along a longitudinal axis from a first end to a second end, the elongate body comprising:
a head portion, disposed near the first end of the elongate body, the head portion comprising an aperture;
a neck portion extending distally from the head portion;
a first leg and a second leg, the first and second legs extending distally from the neck portion, the first and second legs forming an elongate opening between the first and second legs; and
a foot portion disposed near the second end of the elongate body, the foot portion forming a connection between the first leg and the second leg, the foot portion being shaped to include a first heel extending outwardly from the first leg,
wherein the foot portion is configured to be inserted through the aperture, the foot portion further configured to be releasably retained through the aperture via the first heel.

2. The retaining device of claim 1, wherein the head portion is generally wider than the neck portion.

3. The retaining device of claim 1, wherein the elongate opening between the first and second legs is configured to be placed over a protruding portion of the object.

4. The retaining device of claim 3, wherein the elongate opening comprises a narrow central portion and enlarged portions at opposite ends of the narrow central portion.

5. The retaining device of claim 1, wherein the aperture of the head portion forms a first slit, the first slit being oriented generally transverse to the longitudinal axis of the elongate body, and wherein the head portion further comprises a second slit, the second slit being oriented generally transverse to the longitudinal axis of the elongate body, the second slit being disposed proximally of the first slit.

6. The retaining device of claim 5, wherein the head portion further comprises an end tab disposed proximally of the first and second slits.

7. The retaining device of claim 6, wherein the end tab includes a hole formed in the end tab to facilitate hanging the retaining device.

8. The retaining device of claim 1, further comprising a first hip at a proximal end of the first leg and a second hip at a proximal end of the second leg, wherein the first and second hips extend outwardly from the longitudinal axis of the elongate body.

9. The retaining device of claim 8, wherein the first and second hips are configured to be placed through the aperture, the first and second hips being releasably retained by the head portion such that the neck portion forms a first loop for retaining one or more strands of the flexible cord.

10. The retaining device of claim 5, wherein the first and second hips are configured to be placed through the first slit or the second slit and releasably retained by the head portion such that the neck portion forms a first closed loop for retaining at least a single strand of the flexible cord.

11. The retaining device of claim 10, wherein the foot portion is configured to be placed through the second slit and releasably retained by the head portion such that the first and second legs form a second closed loop for retaining multiple strands of the flexible cord.

12. The retaining device of claim 1, wherein the foot portion further comprises a second heel extending outwardly from the second leg.

13. The retaining device of claim 10, wherein the elongate opening is configured to be stretched to enable placement of at least one of the first and second legs over a protruding portion of the object.

14. The retaining device of claim 1, wherein the elongate body is formed of flexible rubber material.

15. The retaining device of claim 1, wherein the elongate body is between 1 feet and 5 feet in length.

16. The retaining device of claim 1, wherein the object is an electrical appliance and the flexible cord extending from the electrical appliance is an electrical cord.

17. The retaining device of claim 1, wherein the object is a gas or fluid appliance and the flexible cord extending from the gas or fluid appliance is a flexible hose.

18. The retaining device of claim 17, wherein the object is an air compressor.

19. A method of using a first retaining device with a second retaining device, the first and second retaining devices each comprising:
a head portion, disposed near the first end of the elongate body, the head portion comprising a first slit, the first slit being oriented generally transverse to the longitudinal axis of the elongate body;
a neck portion extending distally from the head portion;
a first leg and a second leg, the first and second legs extending distally from the neck portion, the first and second legs forming an elongate opening between the first and second legs; and
a foot portion disposed near the second end of the elongate body, the foot portion forming a connection between the first leg and the second leg, the foot portion being shaped to include a first heel and a second heel, the first and second heels extending outwardly of the first and second legs, respectively,
the method comprising:
using the first and second retaining devices to hold two lengths of extension cord together;
wherein the foot portion of the first retaining device is placed through the first slit of the second retaining device and releasably engaged thereto by the head portion of the second retaining device; and
wherein the foot portion of the second retaining device is placed through the first slit of the first retaining device and releasably engaged thereto by the head portion of the first retaining device.
